(19) United States
(12) Patent Application Publication
(10) Pub. No.: US 2009/0307048 A1
(43) Pub. Date: Dec. 10, 2009

(54) METHODS AND SYSTEMS FOR DELIVERING TARGETED ADVERTISEMENTS

(76) Inventor: Jordan Ian Grossman, Lincolnshire, IL (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/133,357

(22) Filed: Jun. 4, 2008

(51) Int. Cl. G06F 17/30

(52) U.S. Cl. 705/10

(57) ABSTRACT

A recipient's viewing or listening attentiveness to an advertisement is identified and subsequent advertisements are targeted to the recipient responsive to the recipient's attentiveness. The recipient may be a viewer or a listener of an advertisement, such as a television commercial. While the recipient is viewing or listening to an advertisement, if the recipient fast-forwards through or interrupts the advertisement, then a subsequent advertisement is chosen that has a higher probability of being viewed in its entirety. Thus, the advertisements are targeted toward the recipient based on the recipient's attentiveness to certain types of the advertisements. This increases the probability that the recipient will watch an entire advertisement, making the advertisement more effective.

### FIELD OF THE INVENTION

The present invention relates to targeting advertising, and in particular, the invention relates to presenting advertisements based on viewing patterns.

### BACKGROUND OF THE INVENTION

Advertisements may be delivered on a variety of media, such as video, audio, and print media. Audio- and video-based advertisements are typically presented along with some other content for the intended recipient. For example, television commercials are typically bundled with a particular television program.

Advertisers conventionally attempt to optimize the effectiveness of audio- and video-based advertisements by presenting advertisements that appeal to the demographic of people who typically receive the associated content. For example, an advertiser may present a television commercial about a physicians group during a television program on health. However, this approach may be ineffective when viewers or listeners fall outside the anticipated demographic, psychographic, or behavior. Further, conventional approaches fail to receive adequate feedback from the viewer to determine whether the advertisement was effective. For example, when advertisements are broadcast wirelessly, the recipients may have no communication back to the advertisers.

The delivery of content from digital communications providers, such as World Wide Web (WWW) providers, cable operators, mobile telephone operators, and satellite operators, provides an opportunity for two-way communication between the advertiser and recipients, or at least an opportunity to gather information about recipients. For example, the provider may know the identity of or other information about the recipient because the recipient has an account with the provider. Further, the provider is able to track which content the recipient views or listens to. Advertisers may use this information to tailor commercials to the recipient based on the recipient's content viewing or listening habits.

However, even conventional approaches that deliver advertisements digitally fail to identify whether recipients are attentive to the advertisements. For example, in video-on-demand systems that presents advertisements along with content, conventional approaches fail to capture information on whether the viewers are fast forwarding or skipping over the advertisements. Further, some video-on-demand systems remove the functionality to fast-forward through advertisements, forcing the viewers to watch the advertisements. Thus, there is a need for identifying recipients' viewing or listening habits of advertisements, so that subsequent advertisements may be effectively targeted.

### SUMMARY OF THE INVENTION

Methods, systems, and articles of manufacture consistent with the present invention identify a recipient's viewing or listening attentiveness to an advertisement and target subsequent advertisements responsive to the recipient's attentiveness. The recipient may be a viewer or a listener of an advertisement, such as a television commercial. Advertisements may be chosen for the recipient based on a variety of criteria. While the user is viewing or listening to an advertisement, if the user fast-forwards or interrupts the advertisement, then the system chooses a subsequent advertisement that it anticipates will be have a higher likelihood of being viewed in its entirety. Thus, the advertisements are targeted toward the recipient based, at least in part, on the recipient's attentiveness to certain types of the advertisements. This increases the probability that the recipient will watch an entire advertisement, making the advertisement more effective.

In accordance with methods consistent with the present invention, a method in a data processing system having a program for targeting advertisements to a recipient is provided. The method comprises:

presenting an advertisement of a plurality of advertisements to the recipient;

determining whether the recipient one of interrupts and fast-forwards through at least a portion of the advertisement; and

identifying a subsequent advertisement responsive to the recipient one of interrupting and fast-forwarding through at least a portion of the advertisement.

In accordance with articles of manufacture consistent with the present invention, a computer-readable medium containing instructions that cause a program in a data processing system having a program to perform a method for targeting advertisements to a recipient is provided. The method comprises:

presenting an advertisement of a plurality of advertisements to the recipient;

determining whether the recipient one of interrupts and fast-forwards through at least a portion of the advertisement; and

identifying a subsequent advertisement responsive to the recipient one of interrupting and fast-forwarding through at least a portion of the advertisement.

In accordance with systems consistent with the present invention, a data processing system for targeting advertisements to a recipient is provided. The data processing system comprises a memory having a program and a processing unit that runs the program. The program:

presents an advertisement of a plurality of advertisements to the recipient;

determines whether the recipient one of interrupts and fast-forwards through at least a portion of the advertisement; and

identifies a subsequent advertisement responsive to the recipient one of interrupting and fast-forwarding through at least a portion of the advertisement.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention.

FIG. 1 depicts a block diagram of a data processing system consistent with the present invention.

FIG. 2 depicts a block diagram of a recipient system.

FIG. 3 depicts a block diagram of a provider system.

FIG. 4 depicts a block diagram of an advertiser system.

FIG. 5 is a flow diagram depicting illustrative steps performed by the provider program for identifying advertisements for a recipient.

FIG. 6 is a flow diagram depicting illustrative steps performed by the provider program for identifying recipient activity using a grouping method.

FIG. 7 is a flow diagram depicting illustrative steps performed by the provider program for identifying recipient activity using neural networking.

### DETAILED DESCRIPTION OF THE PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention identify a recipient's viewing or listening attentiveness to an advertisement and target subsequent advertisements responsive to the recipient's attentiveness. The recipient may be a viewer or a listener of an advertisement, such as a television commercial. Advertisements may be chosen for the recipient based on a variety of criteria. While the user is viewing or listening to an advertisement, if the user fast-forwards or skips the advertisement, then the system chooses a subsequent advertisement that it anticipates will be more aligned with the recipient. Thus, the advertisements are targeted toward the recipient based, at least in part, on the recipient's attentiveness to certain types of the advertisements. This increases the probability that the recipient will watch an entire advertisement, making the advertisement more effective.

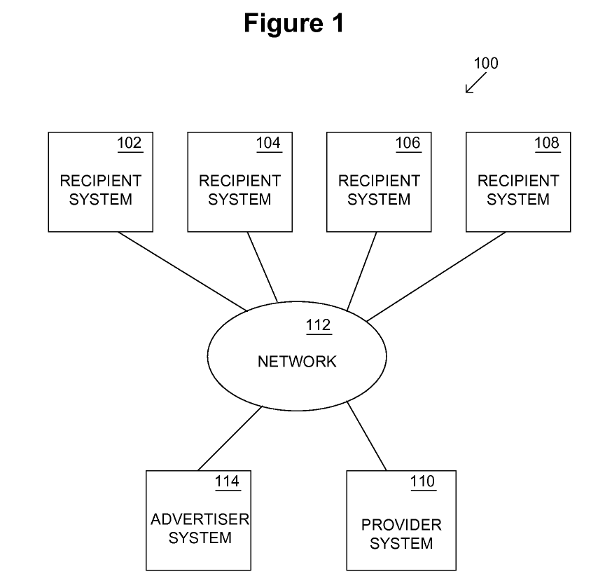

FIG. 1 is a block diagram of an illustrative system suitable for practicing the present invention. In the illustrative system, one or more recipient systems 102-108 communicate with a provider system 110 via a network 112. The recipient systems are data processing systems at the recipients' locations that are able to receive advertisements from the provider system via the network. For example, the recipient systems may be set-top boxes, computers, mobile telephones, hand-held computing devices, and the like. These recipient systems may be any kind of device equipped with hardware and software in accordance with methods and systems consistent with the present invention.

Further, the recipient systems are capable of receiving input from a user requesting to view content data, including advertisements. The user can input the user's request, for example, by making an input selection with a mouse click or a button press on a remote control, with entry of input keys on the client, or by using the user's voice. The content data can be, for example, a video or audio program.

The provider system is a data processing at a provider location that delivers one or more advertisements to the one or more recipient systems. In the illustrative example, the provider system is a data processing system at a video-on-demand service provider and the advertisements may be associated with content that is requested by the recipient. However, the provider may be any type of provider that can deliver advertisements to the recipient systems via the network, such as a World Wide Web (WWW) provider, cable operator, mobile telephone operator, satellite operator, and the like. Although only one provider system is depicted in FIG. 1, one having skill in the art will appreciate that there may be a plurality of provider systems. The provider system may receive advertisements from an advertiser system 114 via the network.

The network is of a type that is suitable for connecting the recipients and provider for communication, such as a circuit-switched network or a packet-switched network. Also, the network may include a number of different networks, such as a local area network, a wide area network such as the Internet, telephone networks including telephone networks with dedicated communication links, connection-less networks, and wireless networks. The netowrk may be, for example but is not limited to, the World Wide Web (WWW), a cable television network, a cellular communication network, a wireless communication network, a fiber-based communication network, a satellite communication, and the like. Each of the recipients and provider shown in FIG. 1 is connected to the network via a suitable communication link, such as a dedicated communication line or a wireless communication link.

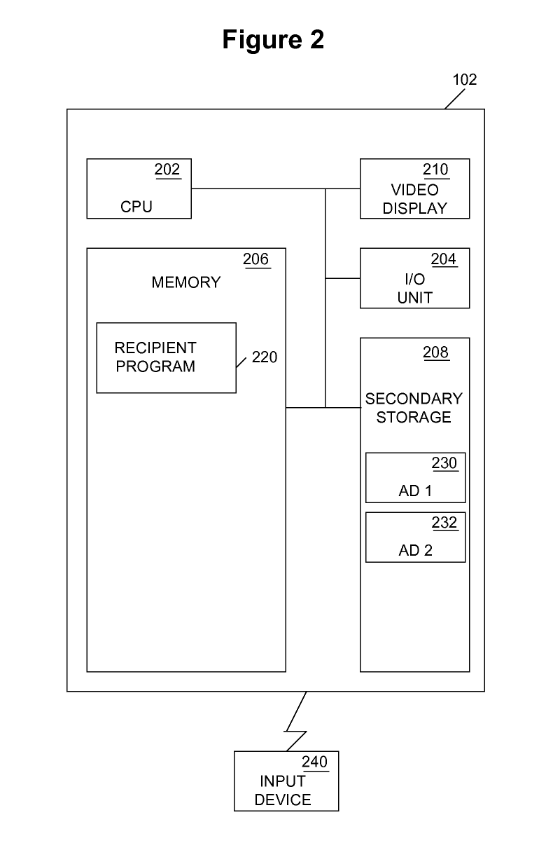

FIG. 2 is a block diagram that shows recipient system 102 in more detail. The illustrative recipient system in FIG. 2 is also representative of the other recipient systems 104-108. The recipient system comprises a central processing unit (CPU) 202, an input output I/O unit 204, a memory 206, a secondary storage device 208, and a video display 210. The recipient system may further comprise standard input devices such as a keyboard, a mouse, wireless or wired remote control, or a speech processing means (each not illustrated).

Memory 206 contains a recipient program 220 that receives and presents advertisements, as well as content, to the recipient. The recipient program also receives user input from the recipient to control the presentation of the advertisement and content, such as play, pause, stop, fast forward, and rewind controls

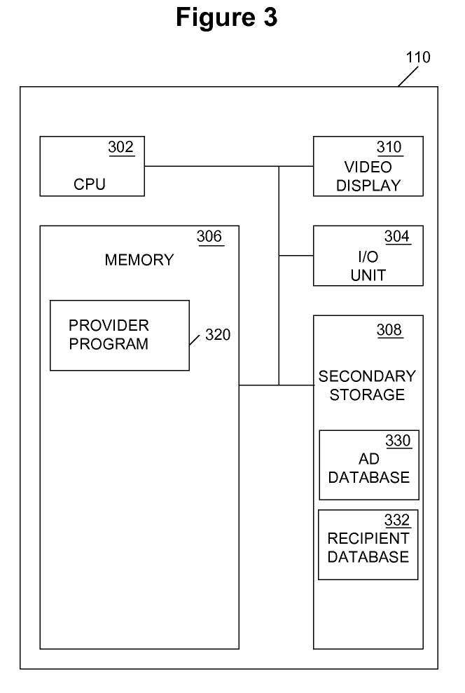

FIG. 3 is a block diagram that shows provider system 110 in more detail. The provider system comprises a central processing unit (CPU) 302, an input output I/O unit 304, a memory 306, a secondary storage device 308, and a video display 310. The provider system may further comprise standard input devices such as a keyboard, a mouse, or a speech processing means (each not illustrated). Memory 306 contains a provider program 320 that receives advertisements, for example from the advertising system, and presents advertisements, as well as content, to the recipient systems. The provider program also determines which advertisements will be presented to the recipient, as will be described in more detail below.

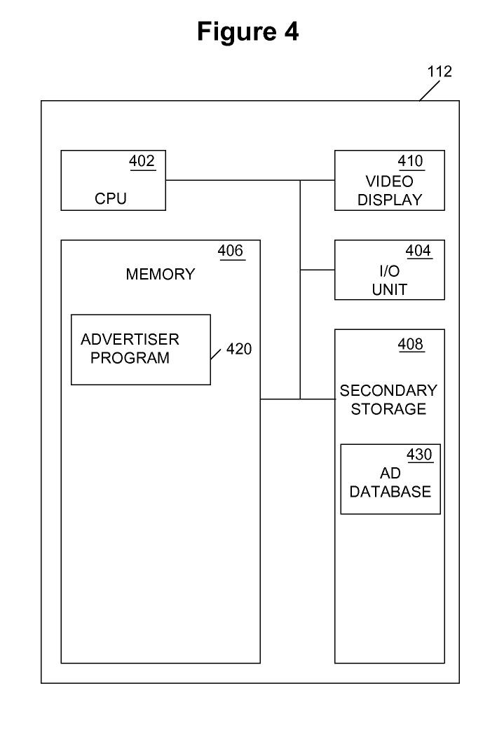

FIG. 4 is a block diagram that shows advertiser system 112 in more detail. The advertiser system comprises a central processing unit (CPU) 402, an input output I/O unit 404, a memory 406, a secondary storage device 408, and a video display 410. The advertiser system may further comprise standard input devices such as a keyboard, a mouse, or a speech processing means (each not illustrated). Memory 406 contains an advertiser program 420 that sends advertisements to the provider system.

Each of the programs in their respective memories will be described in more detail below. The programs may comprise or may be included in one or more code sections containing instructions for performing their respective operations. While the programs are described as being implemented as software, the present implementation may be implemented as a combination of hardware and software or hardware alone. Also, one of skill in the art will appreciate that programs may comprise or may be included in a data processing device, which may be a server, communicating with the respective data processing system.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM, or other forms of ROM or RAM either currently known or later developed. Further, although specific components of data processing system 100 have been described, one skilled in the art will appreciate that a data processing system suitable for use with methods, systems, and articles of manufacture consistent with the present invention may contain additional or different components.

In the illustrative example, the provider having the provider system receives content (e.g. movies) from content providers (e.g., movie studios) and advertisements from the advertising system. The provider may alternatively receive content and advertisements from alternative sources, such as from distributors and the like. One or more of the content items may be coupled with one or more advertisements, so that when the content is presented to a recipient, the content is viewed or listened to with the one or more advertisements. The advertisements and their associations with content are stored in the advertisement database 330.

The provider associates the advertisements with recipients in an attempt to make the recipients more attentive to the advertisements. To do so, the provider may gather information about recipients, their preferences, and viewing habits and identifies effectiveness of the respective advertisements. In an example, the provider may prompt a sample of the total recipient population with a questionnaire on advertisement viewing or listening preferences. The questionnaire may include questions on, for example, likes and dislikes of general advertising, various product sectors, brands, products, and the like. The provider may also gather information on recipient product purchases to, which content the recipients like to watch or are watching, as well as other behavioral data target the advertisements.

Then, the provider draws relationships between the recipients, based on the received recipient information, and the advertisements. For example, an advertisement for basketball shoes may be associated with recipients who like to watch basketball programs, like sports, or buy basketball shoes.

In addition, the provider identifies when recipients alter the normal presentation of advertisements, such as by fast-forwarding through or interrupting advertisements. If a recipient fast-forwards or interrupts through an advertisement, it is likely that the advertisement is ineffective to the respective recipient. Therefore, this behavioral data provides beneficial real-time feedback to the provider on an advertisement's effectiveness. The provider may use this behavioral history information together with the other factors described above to match subsequent advertisements to recipients or groups of recipients. For example, if a recipient who likes basketball does not fast-forward through a particular advertisement about basketball shoes, then there is a likelihood that other recipients who like basketball will not fast-forward through the commercial.

The provider may use one or more of a variety of approaches to match recipients to advertisements. For example, the provider may use grouping methods, segmentation methods, latent class analysis, cluster analysis, regressions, neural networking, tailored interviewing, probabilistic analysis, efficiency analysis, and the like. Probabilistic approaches are known to one having skill in the art and will not be described in more detail herein.

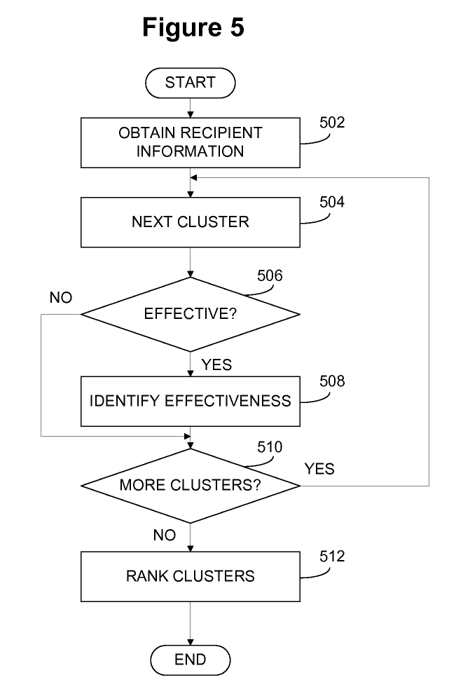

FIG. 5 depicts a flow diagram illustrating exemplary steps performed by the provider program for determining one or more advertisements to send to the recipient in accordance with methods, systems, and articles of manufacture consistent with the present invention. Initially, the provider program obtains information about the recipient in order to match the recipient to one or more advertisements (step 502). When a recipient initially engages with the provider to receive content, it is possible that the provider has no information about the recipient that would allow the provider to determine which types of advertisements will be presented to the recipient. In this case, the provider may gather additional information about the user, such as demographic information, in order to determine the effectiveness of advertisements. For example, the recipient may respond to a questionnaire that may include questions, for example, on likes and dislikes of general advertising, various product sectors, brands, products, and the like. The provider may also gather information on the recipient's product purchases, which content the recipients like to watch or are watching, as well as other behavioral data.

The provider may use a variety of analyses to match the recipient to advertisements. In an illustrative example, the provider program may use a cluster analysis, such as a K-means cluster analysis. Initially, the provider gathers information on other recipients to build a model. For example, the provider may prompt a sample of the total recipient population with a questionnaire on commercial viewing preferences. The questionnaire may includes questions, for example, on likes and dislikes of general advertising, various product sectors, brands, products, and the like. This information may be considered in combination with other data about the recipients, such as product purchase information, which content the recipients like to watch or are watching, fast-forwarding and interruption histories, as well as other behavioral data.

In the illustrative example, the provider program groups recipients with particular advertisements based on one or more recipient characteristics, such as their preferences, fast-forwarding and interruption histories, and the like. For example, the group of the recipient population that does not fast-forward through commercials on basketball shoes are grouped together with one or more commercials on basketball shoes. The provider program attempts to group or segment recipients to decrease the incidence of fast-forwarding or advertisement interruption.

The K-means cluster analysis may be performed for various numbers of clusters. The number of clusters may be determined based on a variety of factors. For example, when expediency is not a priority, then all of the clusters may be analyzed. However, if the analysis is to be performed in a short period of time, then it may be beneficial to obtain a processing result using a smaller number of clusters. When timing is important, such as during content or commercial presentation, the provider program may weigh the benefits of additional cluster numbers against the cost of complexity. A limited number of clusters may be chosen, for example, based on a predetermined number or anticipated time at which the next advertisement must be identified.

After the number of clusters is decided upon, the assigned clusters may be ordered, for example by size, with the largest membership first. Alternatively, the clusters may be arranged by another criteria, such as, the number of similar data items to the recipient's background information. For example, the provider program may compare the recipient's background information to a first cluster (step 504). The provider program may, for example, look at all of the background information on the recipient and compare one or more of the data items to related data items for recipients in the cluster. Alternatively, the cluster itself may be identified as having members with certain values for the respective data items. In this case, the cluster itself may be analyzed. If there is a match between one or more of the recipient's data items and the cluster or the cluster's members (step 506), then it is determined that there is a high probability that the advertisements associated with the cluster will be effective for the recipient (step 508).

If there are more clusters to analyze (step 510), then the program flow returns to step 504 to analyze the next cluster. After the clusters have been analyzed, the relevant clusters are ranked (step 512). As described above, clusters may be ranked, for example, based on cluster size, relevance to the recipient, or some other criteria.

In another illustrative example, the provider program may use a latent class analysis to match the recipient with advertisements. Latent class analysis is a more robust segmentation technique. This type of analysis uses statistical techniques to minimize variance/heterogeneity within the sample be determining the class or group of maximum likelihood.

If the heterogeneity of groups cannot be explained by a grouping, then additional techniques may be used, such as regressions, Bayesian analytics, or neural networking.

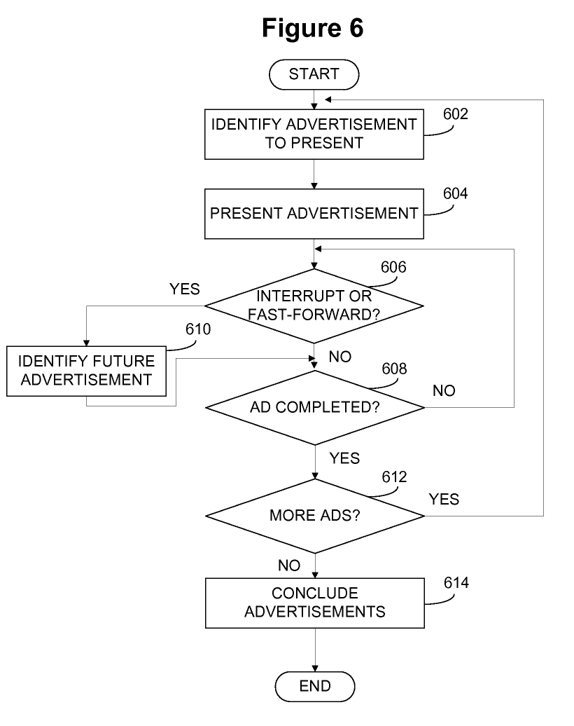

FIG. 6 is a flow diagram depicting exemplary steps performed by the provider program for identifying the recipient's attentiveness and determining one or more subsequent advertisements responsive to the recipient's attentiveness. The illustrative steps described with reference to FIG. 6 are described in the context of an illustrative example in which cluster analysis is used to determine subsequent advertisements.

First, the provider program identifies an advertisement to present to the recipient (step 602). This may be done, for example, when the recipient is viewing a content (e.g., an on-demand program) that has an advertisement associated with the content. For example, the advertisement may be a commercial that occurs during a commercial break. In another example, the advertisement may be presented to the recipient without being associated to a particular content. For example, the provider may send a test commercial to the recipient in order to determine the recipient's response to the commercial. For this case, the provider chooses the advertisement. For other cases, the provider program may automatically choose the advertisement as described above with reference to FIG. 5.

Then, the provider program presents the advertisement to the recipient (step 604). This may be done for example, by sending the advertisement from the provider system to the recipient system. Alternatively, the provider program may effect transmission of the advertisement from another source, such as the advertiser system or a remote server. The advertisement may be delivered to the recipient in a variety of manners, such as, as a streaming content or uploaded to the recipient system, where it is stored in memory 230 and 232 and played from there, and the like.

While the recipient views or listens to the advertisement, the recipient program determines whether it receives an input from the recipient to control the play of the advertisement (step 606). The input may be received from any type of device that provides input to the recipient system. For example, the input may be received from a remote control, a keyboard, a mouse, an actuator input on a set-top box, a keypad, a mobile telephone, and the like. In the illustrative example, the input device 240 is a remote control that communicates wirelessly with the recipient system. The input data may be, for example, a control signal to play, stop, pause, rewind, skip, or fast-forward. One having skill in the art will appreciate that other types of control signals may be used, such as save, change channel, power off, and the like.

If the recipient program receives a signal from the input device to alter the normal presentation of the advertisement, such as by fast-forwarding or interrupting the advertisement, then the recipient program sends a message to the provider program that the signal has been received (step 606). If no signal to alter the presentation of the advertisement has been received (step 608), then the provider program continues to monitor for such a signal until the advertisement is completed.

However, if the provider program receives a message that the program presentation has been altered (e.g., by fast-forwarding or interruption) in step 606, then the provider program uses this information to determine one or more subsequent advertisements (step 610). In the illustrative example, the provider program uses cluster analysis to choose a next cluster. However, the provider program may use another technique for determining a subsequent advertisements. When the one or more subsequent advertisements are determined, the provider program may use the additional knowledge gained about the recipient fast-forwarding or interruption history to determine the subsequent advertisement. Further, the subsequent advertisements do not have to be presented immediately subsequent to the previously-presented advertisement. For example, the provider program may use the recipient's fast-forwarding and interruption history to identify advertisements for a future commercial break or use this information to assist with identifying subsequent advertisements for other recipients.

For example, if K-means cluster analysis is used to identify relevant advertisements, an advertisement from a first cluster is initially chosen that has the highest likelihood of not being fast-forwarded through or interrupted. If the recipient fast-forwards through or interrupts the advertisement, then the recipient would be reassigned to the next cluster, and a subsequent advertisement would be associated with this next cluster. The recipient may be reassigned to a different cluster each time the recipient alters presentation of an advertisement. If all clusters have been used, then the provider program may, for example, return to the initial cluster and continue through the cluster order as fast-forwarding or interruption occurs. Alternatively, the provider program may change to an alternative technique to determine the subsequent advertisement at any time that the recipient alters presentation of an advertisement. The provider program may also periodically perform an analysis, such as a cluster analysis using updated information, to match effective advertisements to recipients.

The provider program may alternatively use other methods to choose the subsequent advertisement. For example, the provider program may choose a subsequent advertisement based on a highest probability of being viewed given the fast-forwarding and interruption history of the population and the individual. That is, the provider program may select a subsequent advertisement based on how other recipients with the same skipping history and preferences have behaved when viewing the same commercials.

When it is determined that an advertisement's presentation is completed, the provider program determines whether there are additional advertisements to present (step 612). For example, there may be additional advertisements to present during a commercial break. If there are more advertisements to present, then the process returns to step 602 to identify another advertisement to present. The subsequent advertisement may have been identified in advance and placed in queue. However, if the recipient altered presentation of the previous advertisement, then the subsequent advertisement that has been placed in queue may be substituted with another advertisement that aligns more properly with the recipient.

If there are no more advertisements to present, then the recipient is presented with non-advertising based content (step 614).

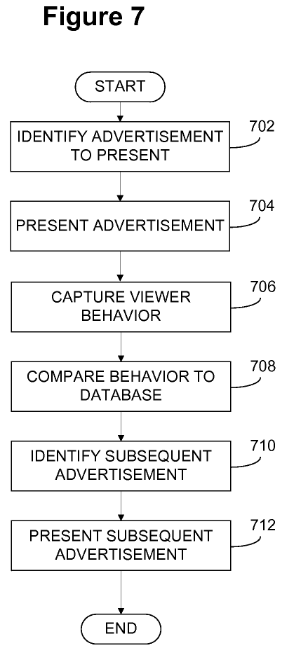

As noted above, the provider program may use a variety of mechanisms to determine subsequent advertisements for the recipient. In another illustrative example, FIG. 7 depicts a flow diagram illustrating exemplary steps performed by the provider program for identifying the recipient's attentiveness and determining one or more subsequent advertisements responsive to the recipient's attentiveness using a neural network.

First, the provider program identifies an advertisement to present to the recipient (step 702). As described above with reference to FIG. 6, this may be done, for example, when the recipient is viewing a content (e.g., an on-demand program) that has an advertisement associated with the content or at other times. The provider program may automatically choose the advertisement as described above with reference to FIG. 5 or the provider may choose the advertisement.

Then, the provider program presents the advertisement to the recipient (step 704). This may be done for example, by sending the advertisement from the provider system to the recipient system. Alternatively, the provider program may effect transmission of the advertisement from another source, such as the advertiser system or a remote server. The advertisement may be delivered to the recipient in a variety of manners, such as, as a streaming content or uploaded to the recipient system, where it is stored and played from there, and the like.

While the recipient views or listens to the advertisement, the recipient program determines whether it receives an input from the recipient to control the play of the advertisement (step 706). The input may be received from a variety of input devices, as described above, and may be for example a control signal to play, stop, pause, rewind, skip, or fast-forward. One having skill in the art will appreciate that other types of control signals may be used, such as save, change channel, power off, and the like. If the recipient program receives a signal from the input device to alter the normal presentation of the advertisement, such as by fast-forwarding, skipping, or stopping the advertisement, then the recipient program sends a message to the provider program that the signal has been received.

When the provider program receives an message that the program presentation has been altered (e.g., by fast-forwarding or interruption) in step 706, then the provider program analyzes the recipient's fast-forwarding and interruption history and preferences in light of the histories and preferences of other recipients, whose information is stored in the recipient database 332 (step 708). Based on the neural network analysis, one or more subsequent advertisements are identified (step 710). The subsequent advertisement may then be presented to the recipient (step 712).

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method in a data processing system having a program for targeting advertisements to a recipient, the method comprising the steps of:
presenting an advertisement of a plurality of advertisements to the recipient;
determining whether the recipient one of interrupts and fast-forwards through at least a portion of the advertisement; and
identifying a subsequent advertisement responsive to the recipient one of interrupting and fast-forwarding through at least a portion of the advertisement.

2. The method of claim 1, further comprising the step of:
presenting the subsequent advertisement to the recipient.

3. The method of claim 1, wherein identifying the advertisement is performed using at least one of grouping, segmentation, latent class analysis, cluster analysis, regression, tailored interviews, and neural networking.

4. The method of claim 1, wherein the advertisement includes at least one of audio and video.

5. The method of claim 1, wherein the advertisement is presented to the user via one of the World Wide Web (WWW), cable television, a cellular communication, fiber-based communication, and a satellite communication.

6. The method of claim 1, wherein the step of identifying the subsequent advertisement includes ranking the advertisement relative to other advertisements based on the advertisements probability of being viewed in its entirety by the recipient.

7. A computer-readable medium containing instructions that cause a program in a data processing system having a program to perform a method for targeting advertisements to a recipient, the method comprising the steps of:
presenting an advertisement of a plurality of advertisements to the recipient;
determining whether the recipient one of interrupts and fast-forwards through at least a portion of the advertisement; and
identifying a subsequent advertisement responsive to the recipient one of interrupting and fast-forwarding through at least a portion of the advertisement.

8. The computer-readable medium of claim 7, further comprising the step of:
presenting the subsequent advertisement to the recipient.

9. The computer-readable medium of claim 7, wherein identifying the advertisement is performed using at least one of grouping, segmentation, latent class analysis, cluster analysis, regression, tailored interviews, and neural networking.

10. The computer-readable medium of claim 7, wherein the advertisement includes at least one of audio and video.

11. The computer-readable medium of claim 7, wherein the advertisement is presented to the user via one of the World Wide Web (WWW), cable television, a cellular communication, fiber-based communication, and a satellite communication.

12. The computer-readable medium of claim 7, wherein the step of identifying the subsequent advertisement includes ranking the advertisement relative to other advertisements based on the advertisements probability of being viewed in its entirety by the recipient.

13. A data processing system for targeting advertisements to a recipient comprising:
a memory having a program that
presents an advertisement of a plurality of advertisements to the recipient;
determines whether the recipient one of interrupts and fast-forwards through at least a portion of the advertisement; and
identifies a subsequent advertisement responsive to the recipient one of interrupting and fast-forwarding through at least a portion of the advertisement.

14. The data processing system of claim 13, further comprising the step of:
presenting the subsequent advertisement to the recipient.

15. The data processing system of claim 13, wherein identifying the advertisement is performed using at least one of grouping, segmentation, latent class analysis, cluster analysis, regression, tailored interviews, and neural networking.

16. The data processing system of claim 13, wherein the advertisement includes at least one of audio and video.

17. The data processing system of claim 13, wherein the advertisement is presented to the user via one of the World Wide Web (WWW), cable television, a cellular communication, fiber-based communication, and a satellite communication.

18. The data processing system of claim 13, wherein the step of identifying the subsequent advertisement includes ranking the advertisement relative to other advertisements based on the advertisements probability of being viewed in its entirety by the recipient.
